(19) United States
(12) Patent Application Publication
(10) Pub. No.: US 2007/0100678 A1
(43) Pub. Date: May 3, 2007

(54) System and Method for Exercising Peremptory challenges During Jury Selection

(76) Inventors: Leon J. Reymond III, New Orleans, LA (US); John Jerry Glas, Metairie, LA (US)

Correspondence Address: CONLEY ROSE, P.C., P. O. BOX 3267, HOUSTON, TX, 77253-3267, US

(21) Appl. No.: 11/554,462

(22) Filed: Oct. 30, 2006

Related U.S. Application Data
(60) Provisional application No. 60/731,083, filed on Oct. 28, 2005.

(51) Int. Cl. G06F 9/46

(52) U.S. Cl. 705/9

(57) ABSTRACT

A system and method is provided for determining whether an attorney should exercise a peremptory challenge to excuse a prospective juror based on, for example: (1) the location of the juror in the selection order; (2) the rank or score assigned to each potential peremptory challenge; (3) the jurors identified as potential challenges for cause; (4) the probability of dismissal assigned to each potential challenge for cause; (5) the number of jurors needed to serve on the jury; (6) the number of peremptory challenges allowed by the court; (7) the number of jurors in the panel; and (8) the jurors who have already been selected dismissed for cause, or peremptorily challenged.

### REFERENCE TO RELATED APPLICATIONS

This application claims the benefit of U.S. Provisional Patent Application Ser. No. 60/731,083, filed Oct. 28, 2005 (hereinafter referred to as “Provisional Patent Application”), which is hereby incorporated herein by reference in its entirety.

### STATEMENT REGARDING FEDERALLY SPONSORED RESEARCH OR DEVELOPMENT

Not Applicable

### BACKGROUND OF THE INVENTION

1. Field of the Invention

The embodiments of the inventions disclosed here relate to systems and methods for exercising peremptory challenges during jury selection. More specifically, the embodiment can include systems, methods, and computer programs designed to help an attorney exercise peremptory challenges during jury selection.

2. Description of the Related Art

An attorney is only allowed to exercise a finite number of peremptory challenges during jury selection. As a result, an attorney is forced to compare prospective jurors, and to decide which jurors will be fair, or more favorable, to their client. That decision will always be subjective.

An attorney may like a juror for a variety of reasons, including but not limited to: (1) the answers and behavior of thee juror: (2) the instinct and prior experience of the attorney; (3) the parties and the witnesses who are involved in the case; (4) the legal and factual issues that will decide the case; and (5) the performance and opinions of similar jurors in the past.

It is often a difficult and personal decision for a trial attorney. Some trial attorneys rely on “gut instinct.” Others rely on jury selection research performed by trial consultants.

Trial attorneys have routinely used systems or methods for conducting jury selection research, for organizing and conducting mock trials, and for analyzing and utilizing the data obtained. For example, application Ser. No. 10/465,434 is directed to one such system or method and is entitled Systems And Methods For Conducting Jury Selection Research, US PAT APP 20040002044. The systems in that application focus on establishing a means of collecting, organizing, and presenting statistical and demographical data, which the trial attorney can consider, or completely ignore, before evaluating a prospective juror

Trial attorneys have routinely used systems or methods of providing attorneys with a means of recording, accessing, incorporating, or even deferring to statistical or demographical data that has already been collected. For example, application Ser. No. 10/980,814 entitled Method And Apparatus For Selecting A Jury discloses systems focused on establishing a means of scoring, recording, and recalling biographical or demographical information about the prospective jurors, which the trial attorney can consider, or completely ignore, before evaluating a prospective juror.

These systems may or may not serve their intended purpose, but their usefulness ends after the attorney has scored the prospective jurors, or after the apparatus displays the scores previously entered by the attorney.

None of these systems is capable of telling an attorney: (1) which prospective jurors in the panel have already been mathematically eliminated from service on the jury; (2) how many peremptory challenges should be used during the panel; and (3) who will be the last juror selected if the parties exhaust their peremptory challenges.

Proper jury selection involves math, and that math can be intimidating. For example, let us assume that a plaintiff attorney is picking a jury of six for a civil trial. The court allows each side to exercise three peremptory challenges, and puts fourteen prospective jurors “in the box” for each panel of voir dire. The court does not allow the attorneys to challenge a juror for cause until the court reaches that juror in the selection order.

During the first panel, the court grants eight challenges for cause; the parties select four principal jurors; the plaintiff attorney exercises one peremptory challenge; and the defense exercises one peremptory challenge.

During the second panel, the following occurs: the Court dismisses juror # 15 for cause; the parties select juror # 16 as the fifth principal juror; the defense exercises a peremptory challenge to excuse juror # 17; the plaintiff exercises a peremptory challenge to excuse Juror #18; and the court dismisses Juror # 19 for cause. When the court reaches Juror # 20 in the selection order, the defense attorney announces that Juror # 20 is “acceptable.”

It is the plaintiff's turn. The court quickly asks the plaintiff attorney if Juror # 20 is “acceptable”. At that time, the plaintiff attorney knows that there are nine prospective jurors remaining in the panel Jurors # 20 through # 28), and believes Juror # 20 is the fourth-worst (i.e., fourth-most unfavorable) of the remaining nine prospective jurors.

Should the attorney accept Juror # 20? Does the attorney have enough information to answer the question? What additional information does the attorney need? If the attorney had that additional information, what specific calculations would still have to be performed, and how quickly could those calculations be performed while the court waited for a reply? Should the answer of the attorney change if Juror # 20 was the third-most unfavorable of the remaining nine prospective jurors? What if Juror # 20 was the fifth-most unfavorable? Should the attorney's answer change if the court had already granted (out of turn) a defense challenge for cause, and dismissed Juror # 21 for cause?

A system or method for making these calculations and recommendations is needed. Attorneys who take the time to score or rank prospective jurors should not waste their effort by: (1) saving peremptory challenges for prospective jurors who have already been mathematically eliminated from service on the jury: or (2) failing to save peremptory challenges for prospective jurors who are still mathematically eligible to serve on the jury.

An embodiment of the invention provides attorneys with a reliable and logical method for exercising peremptory challenges. One embodiment of the system mploys algorithms designed to identify certain numerical sets; makes calculations based on those numerical sets, determines how many peremptory challenges should be used during each panel; and tells the attorney whether to exercise a peremptory challenge on the score or rank the attorney originally assigned to that juror

### SUMMARY OF THE INVENTION

An attorney who has already scored or ranked the unfavorable prospective jurors in the panel should not resort to guessing when deciding whether to “accept” or “cut” a juror. An embodiment of the invention can determine, for example: (1) how many peremptory challenges to use during a specific panel of voir dire: and/or (2) whether to exercise one of those peremptory challenges on a prospective juror.

An embodiment requires an attorney: (1) to identify those prospective jurors on the panel who may require the attorney to exercise a peremptory challenge (“potential peremptory challenges”); (2) to rank or score each identified potential peremptory challenge for the client; (3) to identify those prospective jurors on the panel who may be dismissed for cause by the court (“potential challenges for cause”): (4) to determine the probability that a prospective juror on the panel will be dismissed for cause by the court (“probability of dismissal”); and (5) to identify the number of peremptory challenges that the attorney is willing to exercise during the panel

An embodiment of the invention calculates and identifies mathematical or numerical sets of jurors (“juror sets”), including: (1) the set of mathematically certain prospective jurors; (2) the set of mathematically probable prospective jurors; and (3) the set of mathematically possible prospective jurors. These juror sets do not include those prospective jurors who have already been selected to serve on the jury, dismissed for cause, or dismissed through the exercise of a peremptory challenge. The embodiment can then compare and rank within each juror set every potential peremptory challenge for the client based on the attorney's initial rank or score for each prospective juror.

An embodiment of invention determines which prospective jurors should be peremptorily challenged (“cut”) by the attorney. Within each juror set, the invention recommends that the attorney cut a juror when that juror's rank with the set is less than, or equal to, the number of remaining cuts designated for the panel

Embodiments of the invention can include equations for calculating the number of peremptory challenges that an attorney should exercise during a specific panel of voir dire. These equations are hereinafter referred to as “peremptory equations.”

Embodiments of the invention can assist an attorney by calculating and identifying: (1) the Highest Possible Percentage Of Mathematically Eligible Jurors In The Panel (LPMEJ); (2) the lowest Possible Percentage Of Mathematically Eligible Jurors In The Panel (LPMEJ); (3) the Percentage Of Jurors Already Selected (PJAS); (4) the Percentage Of Peremptory Challenges Already Exercised By Opposing Counsel (POCE); and (5) the average of any selected combination of the aforementioned numbers. These peremptory equations, and methods of applying these equations, including the use of one calculation to establish a minimum number (“hard deck”) of available peremptory challenges, are further discussed below.

Embodiments of the invention can also calculate and identify the Expected Percentage Of Mathematically Eligible Jurors In The Panel (EPMEJ) by additionally factoring the probability of dismissal assigned to each potential challenge for cause. It can further calculate and identify the average of the EPMEJ, and any of the aforementioned peremptory equations, including the HPMEJ, the LPMEJ, the PJAS, and the POCEE, and can also establish the EPMEJ as a minimum number (“hard deck”) of available peremptory challenges.

### BRIEF DESCRIPTION OF THE DRAWINGS

The following Figures describe embodiments of the invention:

FIG. 1 is a flowchart of an embodiment of the invention, according to one embodiment of the invention, from the entering of trial data until the selection of the final principal juror;

FIG. 2 is a flowchart of the process of entering general trial data, according to one embodiment of the invention;

FIG. 3 is a flowchart of the process of entering specific panel data, according to one embodiment of the invention;

FIG. 4 is a flowchart of the process of evaluating the prospective jurors in the panel, according to one embodiment of the invention;

FIG. 5 is a flowchart of the process of determining the maximum number of collective selection decisions that the trial attorney may be required to make during jury selection according to one embodiment of the invention;

FIG. 6 is a flowchart of the process of determining the prospective juror who will be selected last (the “Last Actual Juror”) if all parties exhaust their peremptory challenges, and the court denies all subsequent challenges for cause according to one embodiment of the invention;

FIG. 7 is a flowchart of the process of determining the prospective juror who will be selected last (the “Last Possible Juror”) if the parties exhaust their peremptory challenges, and the court subsequently dismisses for cause only those potential challenge for cause identified by the user according to one embodiment of the invention;

FIG. 8 is a flowchart of the process of determining the prospective juror (the “Last Likely Juror”) who will be selected last if the parties exhaust their peremptory challenges, and the probability of dismissal entered by the attorney for each potential challenge for cause is proven correct by the court's rulings according to one embodiment of the invention;

FIG. 9 is a flowchart of the process of calculating and identifying the members of three juror sets: the set of Mathematically Certain Jurors, the set of Mathematically Likely Jurors, and the set of Mathematically Possible Jurors according to one embodiment of the invention;

FIG. 10 is a flowchart of the process of deciding how many peremptory challenges to designate for use during a specific panel of voire dire, and the number of remaining peremptory challenges that should be exercised during that panel according to one embodiment of the invention:

FIG. 11 is a flowchart of the process of ranking potential peremptory challenges each juror set according to one embodiment of the invention;

FIG. 12 is a flowchart of the process of determining whether the attorney should exercise a peremptory challenge on a prospective juror based on the juror set selected by the attorney according to one embodiment of the invention; and

FIG. 13 is a flowchart of the process of entering selection data according to one embodiment of the invention.

### DETAILED DESCRIPTION

Various embodiments of the invention can be employed with the use of a legal pad, a worksheet, or computer software. One embodiment of the invention, which uses worksheets to employ the invention, is further discussed and demonstrated below and in the Provisional Patent Application, which is incorporated herein by reference in its entirety and for all purposes. Another embodiment of the invention, which employs a computer program or code, is further discussed and demonstrated below and in the Provisional Patent Application, which is incorporated herein by reference in its entirety and for all purposes.

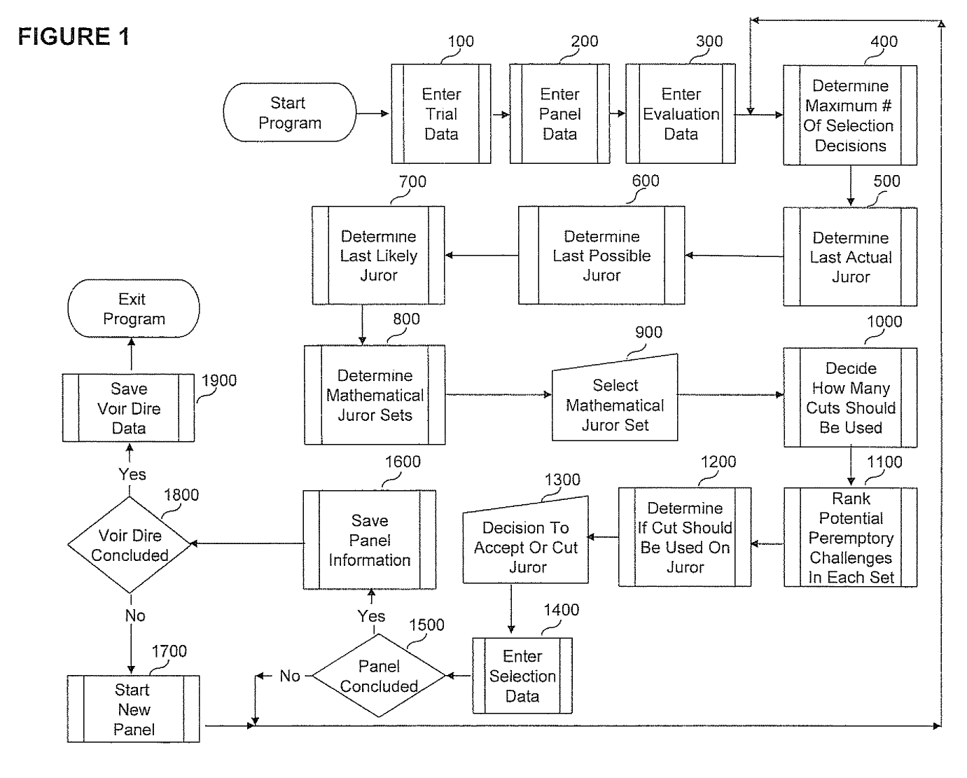

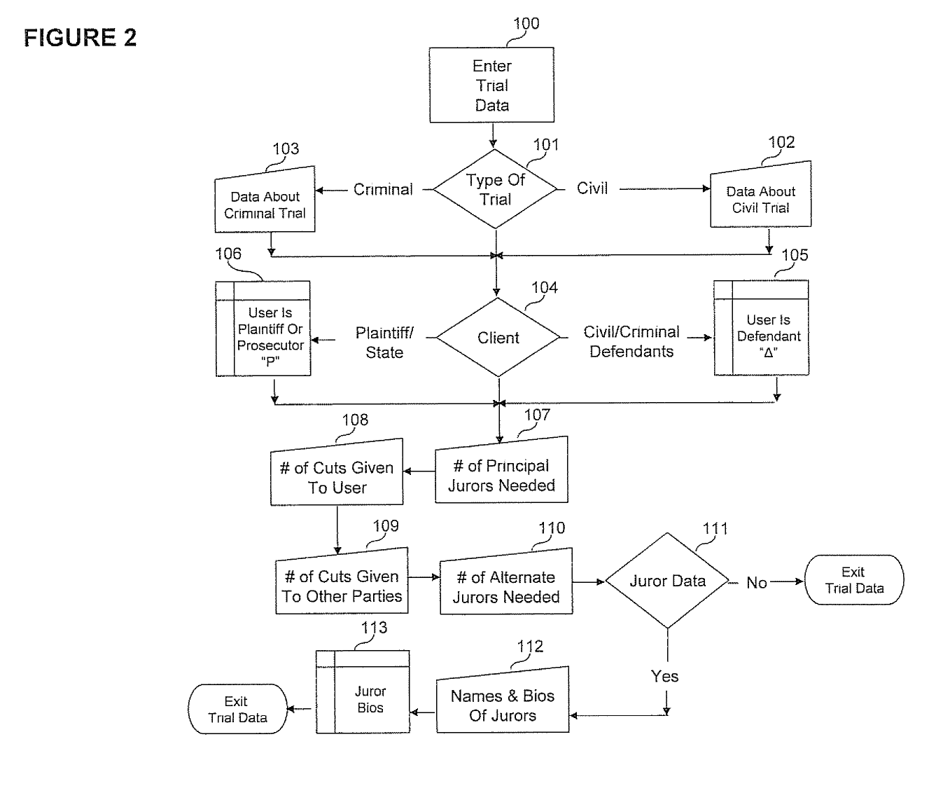

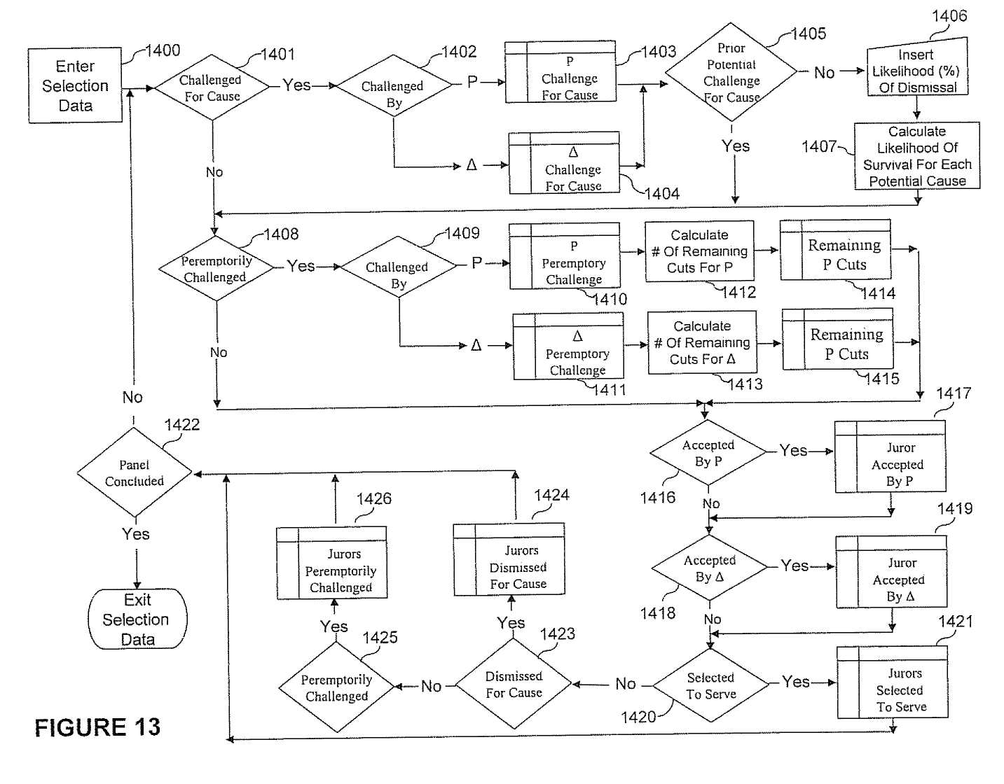

FIG. 1 shows an overview of an embodiment of the invention. In that embodiment, an attorney or other person's (“user”) can follow the method and/or steps shown. Utilizing such method and steps, the invention assists the user in exercising his or her preemption challenges. The steps 100, 200, 300, 400, 500, 600, 700, 800, 900, 1000, 1100, 1200, 1300, 1400, 1500, 1600, 1700, 1800, and 1900 are explained by way of example and in greater detail below and in FIGS. 2 through 13.

Referring now to FIG. 2, one embodiment of the invention is a computer program. It should be understood that, even though the application discusses the inventions in relation to a computer program, the inventions are not so limited. Rather, the method and/or steps described or incorporated herein can be performed in other ways, including but not limited to keeping track or inputting information on a legal pad or a worksheet. The computer program embodiment allows a user to enter basic trial data 100, including the type of trial 101. Before starting a criminal trial, the user enters data 103 about that criminal trial, including but not limited to, the case caption, the parties, the venue, the charges, responsive verdicts, date of the arrest, date of the offense, and date that trial commenced. The user can enter data 102 about that civil trial, including but not limited to, the case caption, the parties, the venue, the claims, the alleged damages, the affirmative defenses, the genuine issues of disputed fact, the date of the incident out of which the lawsuit arises, and the date that trial commenced.

Users identify the client 104. In criminal cases, users indicate 106 that they represent the state by selecting prosecutor (“P”), and indicate 105 that they represent the accused by selecting criminal defense attorney (“Δ”). In civil cases, users indicate 106 that they represent the plaintiff (“P”), or indicate 105 that they represent the defendant (“Δ”).

The user also enters trial data 100, including: (1) the number of principal jurors 107 needed to serve on the jury; (2) the number of peremptory challenges or “cuts” 108 that the user is allowed to exercise during voir dire; and (3) and the number of peremptory challenges 109 that other parties are allowed to exercise during voir dire. If alternate jurors will be used, the invention additionally requires the user to enter the number of jurors needed to serve as alternates 110.

When the user is provided with data about the prospective jurors in the jury pool before the trial begins, the invention allows the user to input the name and biographical information about each prospective juror 112. The invention stores and saves that information as part of each prospective juror's biography (“juror bio”) 113.

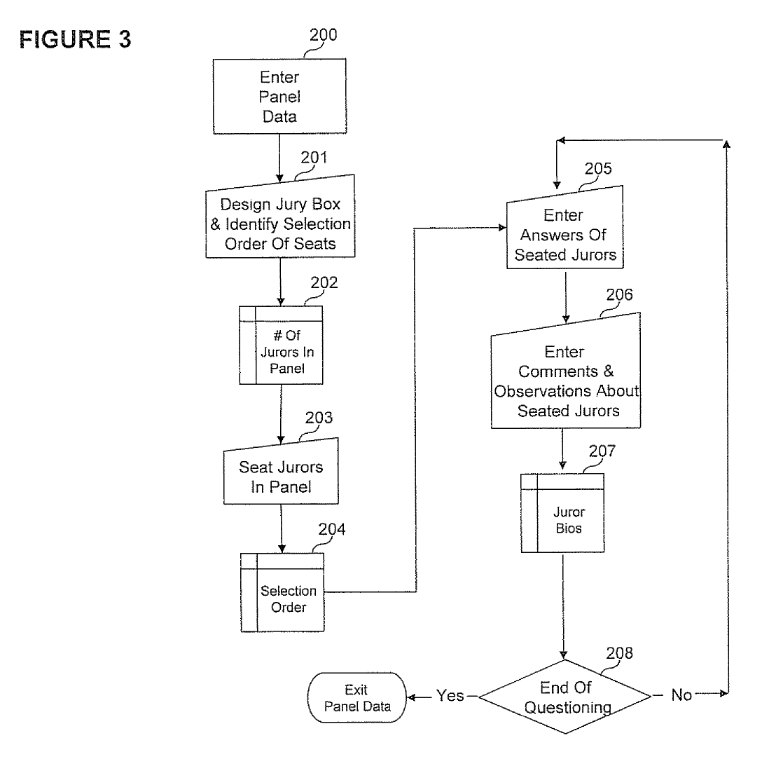

Turning next to FIG. 3 a user can enter panel data 200. One embodiment of the invention allows the user, before trial begins, to design 201 a jury box that resembles the manner in which prospective jurors will be seated in the panel, and to identify 201 the selection order of the juror who will be placed in each seat. The invention then determines and saves the number of prospective jurors in thee current panel 202. The invention then allows the user to seat 203 the prospective jurors, and the invention determines and saves 204 the selection order.

The invention allows the user to record 205 the answers of prospective jurors seated in the panel; and to record 206 any comments, observations, or other data about those jurors. The invention saves and stores 207 the data entered for each prospective juror in the correct juror bio

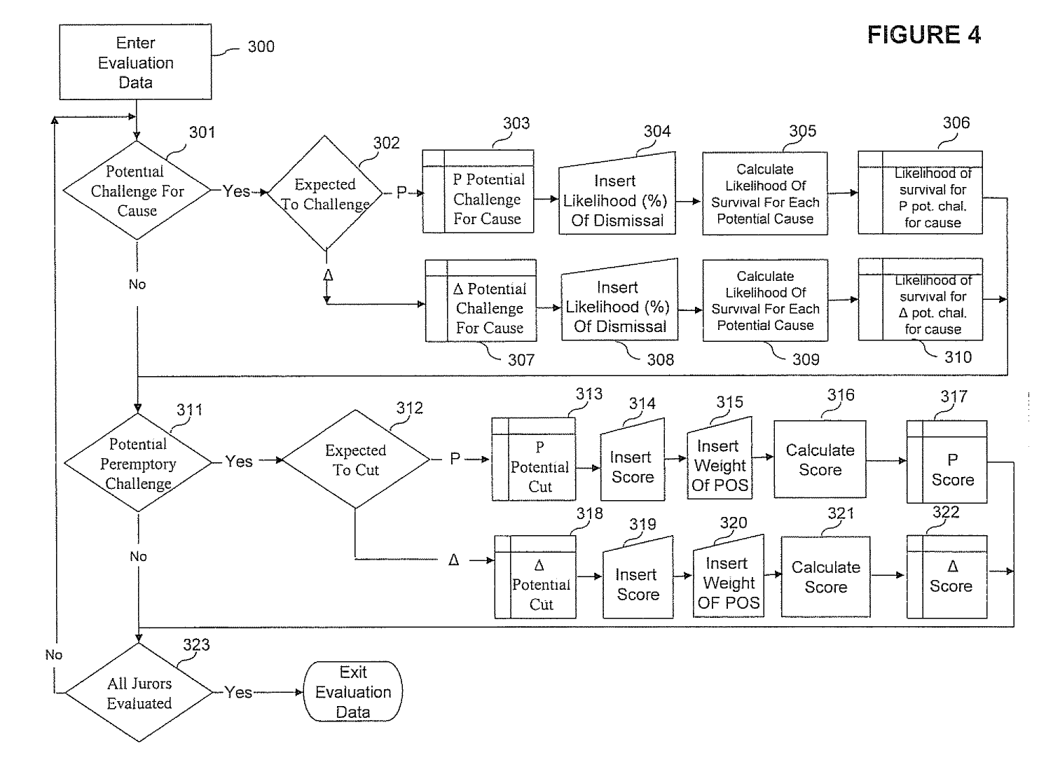

Referring to FIG. 4, the user can enter the user's evaluation of prospective jurors 300. The user can also: (1) identify any prospective juror who the user believes is likely to be dismissed for cause (“potential challenge for cause”) 301; (2) identity the party or parties that the user expected to challenge that for cause 311; and (3) estimate the likelihood that the court will grant the challenge for cause and dismiss the juror (the probability of dismissal”) 304 and 308.

The invention calculates 305 or 309 the probability that a prospective juror will survive a challenge for cause (the “probability of survival”), by subtracting the probability of dismissal from 100%. The invention saves and stores 306 of 310 this data.

For example, let us assume that the user indicates that John Doe is a potential challenge for cause by the plaintiff 303, and indicates that there is a 75% chance that the court will grant the plaintiff's challenge for cause and dismiss John Doe 304. The invention correctly determines 305 that there is a 25% probability of survival for Jane Doe by subtracting the 75% probability of dismissal from 100%, and then saves and stores 306 that probability of survival.

The embodiment shown in FIG. 4 requires the user to identify 311 any prospective juror who could be unfavorable to the user's client, and could warrant the exercise of a peremptory challenge (“potential peremptory challenge”) The user can enter a relative score for each potential peremptory challenge 314 or 319. This store indicates the relative undesirability of each potential peremptory challenge, with the potential juror with the highest score being the most unfavorable potential juror for the user's jury. For example, let us assume that the user represents the plaintiff and is considering exercising a peremptory challenge to excuse Jane Doe. The user indicates 313 that Jane Doe is a potential peremptory challenge for the plaintiff and enters 314 a score on a scale, for example, of one (1) to one-hundred (100), with a score of one-hundred (100) representing the worst possible, or most unfavorable, for the user's client,

The user can assign a weight to the probability of survival 315 or 320. Based on the weight assigned to the probability of survival, the weighted score for each potential peremptory challenge is calculated 316 or 321.

Calculation of Maximum Number of Selection Decisions

Some courts allow attorneys to challenge prospective jurors for cause before the selection process begins (“before selection”). This makes selection easier for the attorneys because, when it is time for them to decide whether to accept the first juror in the selection order, they do not have to worry about saving peremptory challenges “just in case” the court denies or grants certain potential challenges for cause later in the selection order.

Other courts entertain challenges for cause “as they go,” and do not allow attorneys to challenge for cause a prospective juror until they reach that juror in the selection order. This makes selection more difficult for the attorneys because, when it is time for them to decide whether to accept the first juror in the selection, order, they do not know how many challenges for cause will be granted, or which juror will become the last juror selected.

In theory, there is no limit to the number of prospective jurors that the court can dismiss for cause. If the court seats twenty jurors in the first panel, and all twenty jurors have a bias or prejudice that would prevent them from being fair and impartial, then the court could dismiss all twenty jurors for cause.

In contrast, there is a limit to the number of prospective jurors who can be selected; a limit to the number of peremptory challenges that the user, can exercise; and a limit to the number of peremptory challenges that other parties can exercise.

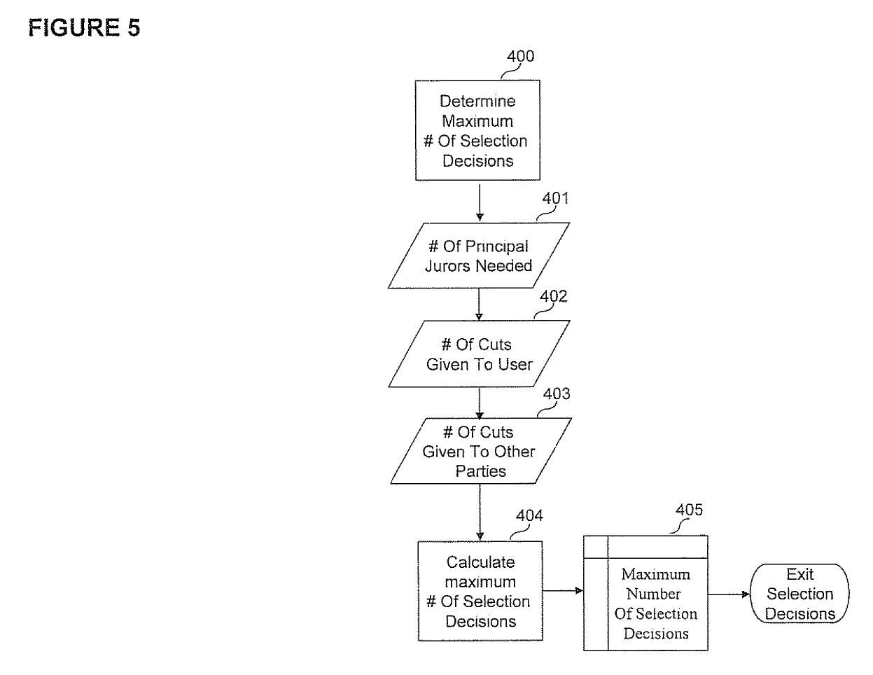

As shown in FIG. 5 for example, the system calculates 400 the maximum number of times that prospective jurors will be selected or peremptorily challenged (“the Maximum Number of Selection Decisions”) by adding 404; the number of jurors needed to serve on the jury 401; the number of peremptory challenges given to the user at the start of selection 402; and the number of peremptory challenges given to other parties at the start of selection 403. Embodiments of the invention can save and store the maximum number of selection decisions 405.

Calculation of the Last Actual Juror

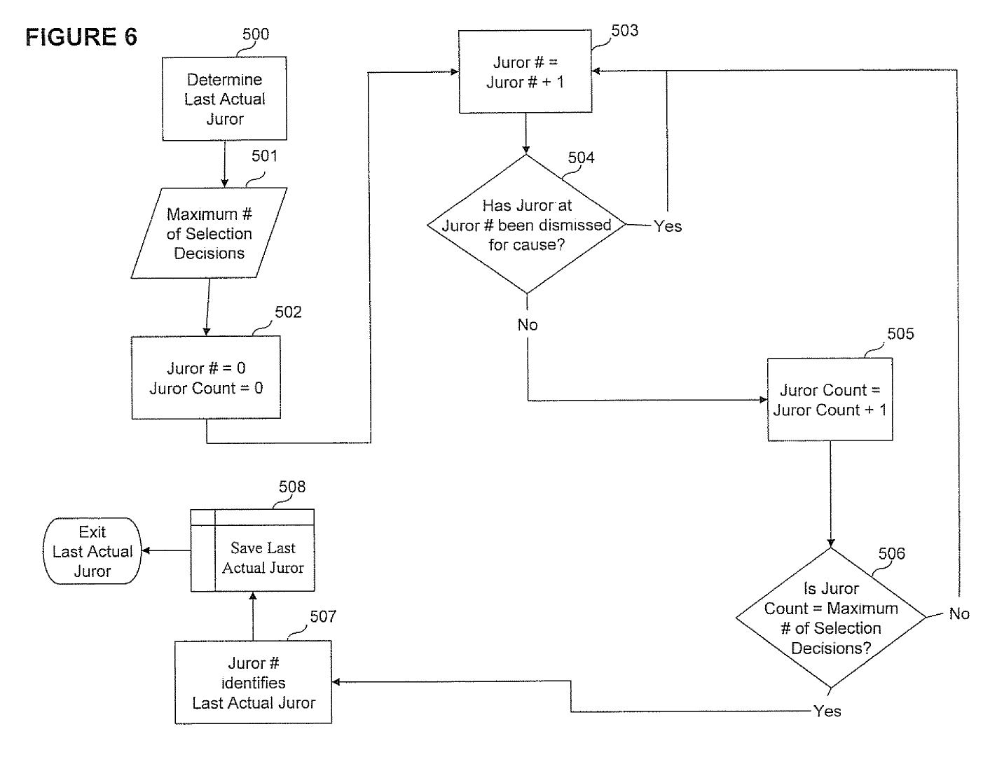

Referring now to FIG. 6, the system calculates 500 the selection order number of the prospective juror who will be selected last if both parties exhaust their peremptory challenges, and the court grants no additional or subsequent challenges for cause (“the Last Actual Juror”).

To perform this calculation, the determination of the last actual juror 500 uses the Maximum Number of Selection Decisions 501. An embodiment of the invention initializes counters 502, Juror # and Juror Court, which will be used to count which juror is being considered, and how many jurors could be selected, respectively.

The calculation 503 preferably begins with incrementing the Juror # counter and considering the identified juror (the first juror). An embodiment of the invention then determines whether this juror should be counted by answering one question: has the juror been dismissed for cause 504. Based on the answer to that question, the Juror Count variable could be incremented 505. If the variable is incremented, then one embodiment of the invention determines 506 whether the Juror Count variable equals the Maximum Number of Selection Decisions 501. When the Juror Count variable equals the Maximum Number of Selection Decisions, then the calculation ends, and the invention saves 508 the Juror # as the Last Actual Juror. If the Juror Count variable does not equal the Maximum Number of Selection Decisions, then the calculation repeats after incrementing the Juror # 503.

Calculation of the Last Possible Juror

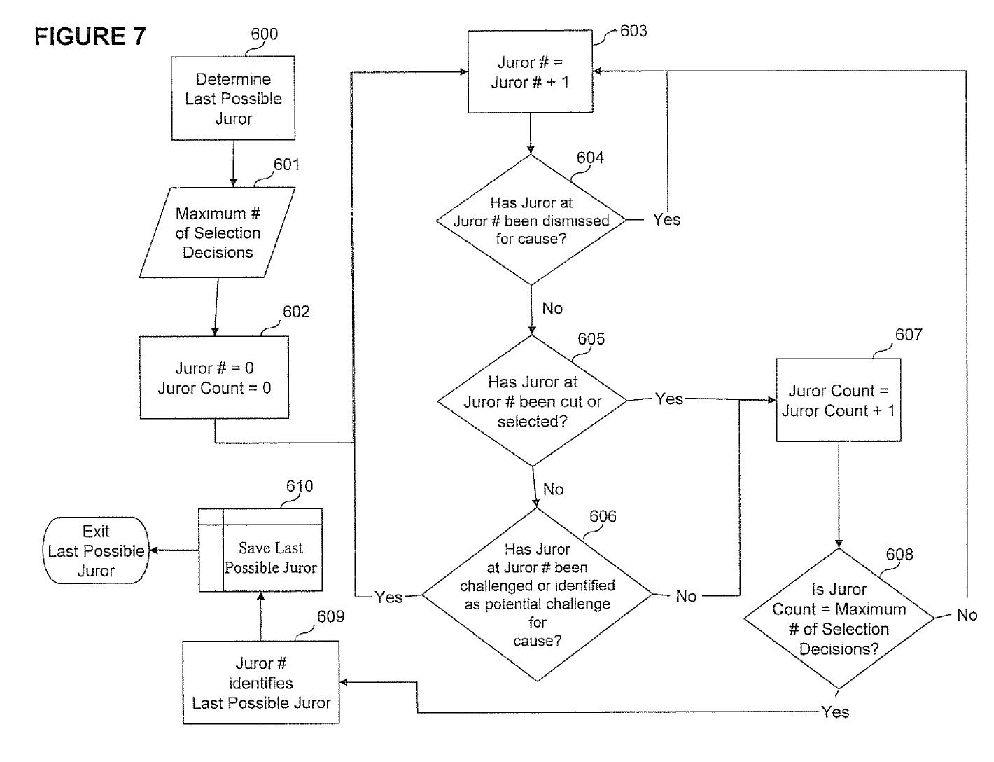

FIG. 7 shows a calculation 600 of the selection order number of the prospective juror who will be selected last if both parties exhaust their peremptory challenges, and the court subsequently dismisses for cause only those potential challenge for cause identified by the user (“the Last Possible Juror”).

To perform this calculation, the system uses the Maximum Number of Selection Decisions 601. The system initializes counters 602, Juror # and Juror Count, which will be used to count which juror is being considered, and how many jurors could be selected, respectively.

The calculation begins 603 by incrementing the Juror # counter, and considering the identified juror (the first juror). Whether this Juror should be counted can be determined by answering three questions: (1) has the juror been dismissed for cause 604; (2) has the juror been peremptorily challenged or selected 605; and (3) has the juror been challenged for cause, or identified by the user as a potential challenge for cause 606 Based oil the answer to those questions, the Juror Count variable could be incremented 607. If the variable is incremented, then the question becomes 608 whether the Juror Count variable equals the Maximum Number of Selection Decisions. When the Juror Count variable equals the Maximum Number of Selection Decisions, then the calculation ends, and the Juror # is saved as the Last Possible Juror 610. If the Juror Count variable does not equal the Maximum Number of Selection Decisions, then the calculation repeats after incrementing the Juror # 603.

Calculation of the Last Likely Juror

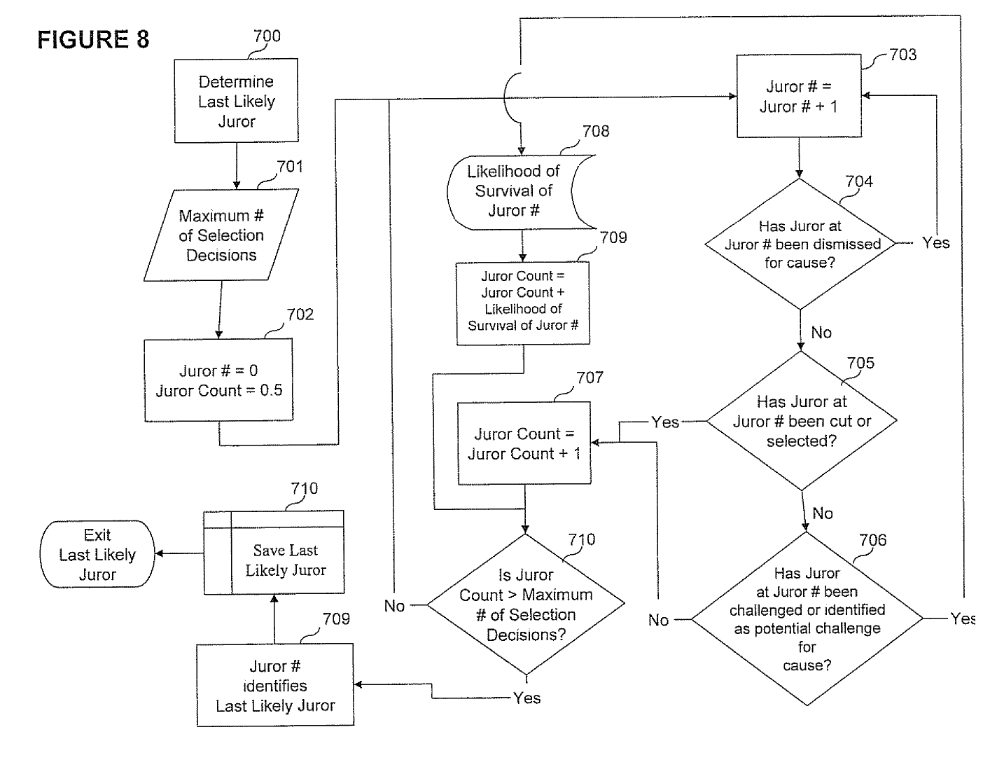

Referring to FIG. 8, the system calculates 700 the selection order number of the prospective juror who will be selected last if both parties exhaust their peremptory challenges, and the probability of dismissal entered by the attorney for each potential challenge for cause is proven correct by the Court's rulings (“the Last Likely Juror”).

To perform this calculation, the system uses the Maximum Number Of Selection Decisions 701. The system can initialize counters 702, Juror # and Juror Count, which will be used to count which juror is being considered, and flow many jurors could be selected, respectively.

The calculation begins 703 by incrementing the Juror # counter, and considering the identified juror (the first juror). An embodiment can then determines whether this Juror should be counted by answering three questions: (1) has the juror been dismissed for cause 704; (2) has the juror been peremptorily challenged or selected 705; and (3) has the juror been challenged for, cause, or identified by the user as a potential challenge for cause 706? Based on the answer to the first two of these three questions, the Juror Count variable could be incremented by one 707. Based on the answer to the third of these three questions, the Juror Count will either be incremented by one 707, or incremented by the probability of survival for that juror 709.

If the variable is incremented, then an embodiment of the invention can determine 710 whether the Juror Count variable exceeds the Maximum Number of Selection Decisions. When the Juror Count variable exceeds the Maximum Number of Selection Decisions, then the calculation ends, and the invention saves 712 the Juror # as the Last Probable Juror. If the Juror Count variable does not exceed the Maximum Number of Selection Decisions, then the calculation repeats after incrementing the Juror # 703.

Example Of Calculating Last Jurors

For example, let us assume that the court is picking a civil jury of six 107; that the user is a plaintiff attorney who is allowed to exercise three peremptory challenges 108; and that the defense is allowed to exercise three peremptory challenges 109. Before the first panel of voir dire begins, the system would correctly calculate 400 that the Maximum Number Of Selection Decisions is twelve. One embodiment of the invention would correctly calculate 500 that the Last Actual Juror is Juror # 12, because the twelfth juror in the selection order will be the last juror selected if all parties exhaust their peremptory challenges, and no jurors are dismissed for cause.

Employing the same example, let us further assume that, during the first panel, the user: (1) identifies Juror # 3 as a potential plaintiff challenge for cause 303, and estimates a 50% probability of dismissal 304; (2) identifies Juror # 5 as a potential defense challenge for cause 307, and estimates a 50% probability of dismissal 308; (3) identifies Juror # 7 as a potential plaintiff challenge for cause 303, and enters a 100% probability of dismissal 304.

In this example, before the court entertained or ruled on any challenges for cause, the system would correctly calculate 500 that the Last Actual Juror was still Juror # 12. Because the user identified three potential challenges for cause within the first fifteen jurors, the system would calculate 600 that the Last Possible Juror was Juror # 15. Finally, because the user identified three potential challenges for cause within the first fourteen jurors, and entered a collective total of 200% in dismissal probability for those three challenges for cause, the system would calculate that only two of the three potential challenges for cause will be granted. The system would calculate 700 that the Last Likely Juror is Juror # 14.

Three Mathematical Juror Sets:

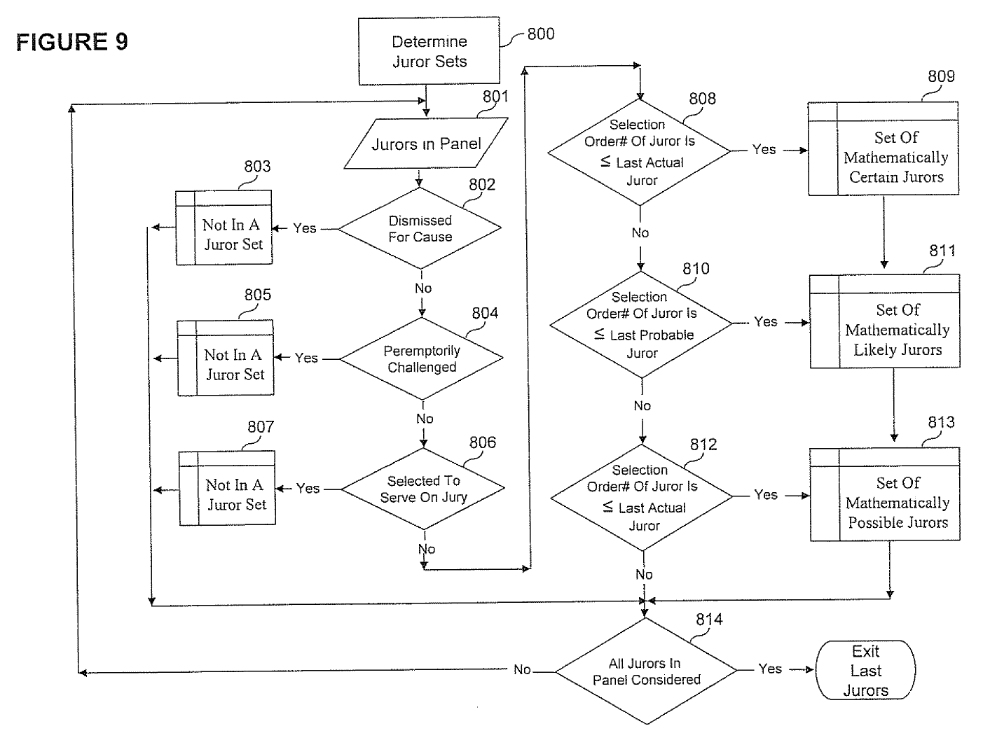

Turning now to FIG. 9, the system identifies 800 three different mathematical or numerical sets of prospective jurors: the set of Mathematically Certain Jurors 809; the set of Mathematically Likely Jurors 811; and the set of Mathematically Possible Jurors 813

A prospective juror is a member of the set of Mathematically Certain Jurors if that prospective juror is: (1) either the Last Actual Juror, or a prospective juror who appears before the Last Actual Juror in the selection order; and (2) has not already been selected, dismissed for cause, or excused through the exercise of a peremptory challenge.

A prospective juror is a member of the set of Mathematically Likely Jurors if that prospective juror is: (1) either the Last Likely Juror, or a prospective juror who appears before the Last Likely Juror in the selection order; and (2) has not already been selected, dismissed for cause, or excused through the exercise of a peremptory challenge.

A prospective juror is a member of the set of Mathematically Possible Jurors if that prospective juror is: (1) either the Last Possible Juror, or a prospective juror who appears before the Last Possible Juror in the selection order; and (2) has not already been selected, dismissed for cause, or excused through the exercise of a peremptory challenge.

In this embodiment, the user would be allowed to select 900 the Set of prospective jurors the system will use when ranking potential peremptory challenges for cause for the user's client; when determining which potential challenges for cause are relevant; when determining which dismissals for cause are relevant; and when determining whether a prospective juror should be peremptorily challenged.

An attorney who wants to “play it safe” may choose to assume that the court will grant every remaining potential challenge for cause; ignore the probability of dismissal; and select the set of Mathematically Possible Jurors 813.

An attorney who wants to take more of a chance may choose to consider the probability of dismissal for each remaining potential challenge for cause, and select the set of Mathematically Likely Jurors 811

An attorney who wants to throw caution to the wind, or an attorney who knows that the judge has never granted a dismissal for cause, may choose to assume that the court will deny all remaining potential challenges for cause, and select the set of Mathematically Certain Jurors 809.

When the user has selected the juror set 900, the system compares and ranks 1100 the scores previously entered by the user for each potential peremptory challenge for the client within each juror set.

For example, let us assume that the user represents the plaintiff, the court is picking a jury of six 107; the court seats twenty prospective jurors in the first panel 202; the plaintiff is allowed three peremptory challenges 108; the defense is allowed three peremptory challenges 109; and the user selects 900 the set of Mathematically Possible Jurors 813 Let us further assume that, during voir dire the user: identifies Juror # 1 and Juror # 13 as potential defense challenges for cause 307, assigns a 50% probability of dismissal for each potential defense challenge for cause 308; and identifies Jurors # 2, 4, 6, 13 and 15 as potential plaintiff peremptory challenges 313. The user then enters 314 the following scores for those potential peremptory challenges: a score of 10 for Juror # 2, who is the least unfavorable; a score of 15 for Juror # 4; a score of 20 for juror # 6; a score of 50 for Juror # 13; and a score of 95 for Juror # 15, who is the most unfavorable. The user assigns 315 zero (0) as the weight to be given the probability of survival, in order to eliminate the probability of survival as a factor.

In this example, the system determines 400 that the Maximum Number Of Selection Decisions is twelve. The system determines that the Last Possible Juror 600 is Juror # 14 because there were two (Juror # 1 and Juror # 13) potential challenges for cause within the first fourteen jurors. The system determines that the set of Mathematically Possible Jurors 813 includes Jurors # 1 through Juror # 14. The potential plaintiff peremptory challenges are then ranked and included in the set of Mathematically Possible Jurors, establishing the following ranking (from most unfavorable to least): Juror # 13; Juror # 6; Juror # 4; and Juror # 2. Because the Last Possible Juror is a member of the current voir dire panel, it is recommended that the user exercise all three peremptory challenges during the panel, and that the user exercise those three peremptory challenges on Juror # 13, Juror # 6, and Juror # 4. It should be noted that, although the user deemed Juror # 15 to be the most unfavorable in the panel, the system would advise the user not to save a peremptory challenge for Juror # 15, because Juror # 15 would never be considered for the jury.

Peremptory Equations

It is important to know whether the court will be required to seat another panel of voir dire in order to complete jury selection. The system determines whether every member of the mathematical set of jurors selected by the user appears in the current panel. If every member does appear in the current panel, then the system recommends that the user exercise all remaining peremptory challenges during the panel. If every member does not appear in the current panel, then the system asks the attorney to decide 1000 the number of peremptory challenges that will be used during the panel. That can be a very difficult decision.

One embodiment of the invention calculates the Highest Possible Percentage Of Mathematically Eligible Jurors In The Panel (HPMEJ) by counting the number of prospective jurors in the panel who are members of the set of Mathematically Possible Jurors, and then dividing that number by the total number of prospective jurors in the set of Mathematically Possible Jurors. If the user selects this peremptory equation, then an embodiment of the invention counts the number of remaining peremptory challenges for the user, and multiplies that number by the Highest Possible Percentage Of Mathematically Eligible Jurors In The Panel (HPMEJ), to determine the number of peremptory challenges the user should use before the conclusion of the panel.

An embodiment of the invention calculates the Lowest Possible Percentage Of Mathematically Eligible Jurors In The Panel (LPMEJ) by counting the number of prospective jurors in the panel who are members of the set of Mathematically Certain Jurors, and then dividing that number by the total number of prospective jurors in the set of Mathematically Certain Jurors. If the user selects this peremptory equation, then an embodiment of the invention can count the number of remaining peremptory challenges for the user, and multiplies that number by the Lowest Possible Percentage Of Mathematically Eligible Jurors In The Panel (LPMEJ), to determine the number of peremptory challenges the user should use before the conclusion of the panel.

One of the embodiments of the invention calculates the Expected Percentage Of Mathematically Eligible Jurors In The Panel (EPMEJ) by counting the number of prospective jurors in the panel who are members of the set of Mathematically Likely Jurors, and then dividing that number by the total number of prospective jurors in the set of Mathematically likely Jurors. If the user selects this peremptory equation, then one embodiment can count the number of remaining peremptory challenges for the user, and multiplies that number by the Expected Percentage Of Mathematically Eligible Jurors In The Panel (EPMEJ), to determine the number of peremptory challenges the user should use before the conclusion of the panel.

An embodiment of the invention calculates the Percentage Of Jurors Already Selected (PJAS) by counting the number of prospective jurors who have already been selected to serve as principal jurors on the jury, and dividing that number by the total number of principal jurors needed to serve on the jury. If the user selects this peremptory equation, then an embodiment of the invention takes the total number of peremptory challenges that the user is allowed to exercise during voir dire, and multiplies that number by the Percentage Of Jurors Already Selected (PJAS), to determine the number of peremptory challenges the user should use before the conclusion of the panel,

One embodiment of the invention calculates the Percentage of Peremptory Challenges Already Exercised By Opposing counsel (POCE) by counting the number of peremptory challenges exercised (by Opposing counsel, and dividing that number by the number of peremptory challenges that the other parties are allowed to exercise during voir dire. If the user selects this peremptory equation, then an embodiment of the invention can take the total number of peremptory challenges that other parties are allowed to exercise during voir dire, and multiplies that number by the Percentage Of Peremptory Challenges Already Exercised By Opposing Counsel (POCF).

An embodiment of the invention allows the user to select one of these peremptory equations, or an average of any two or more peremptory equations An embodiment of the invention also allows the user to select one of these peremptory equations, or an average of any two or more peremptory equations, to establish a minimum or maximum number of peremptory challenges to be used during any panel.

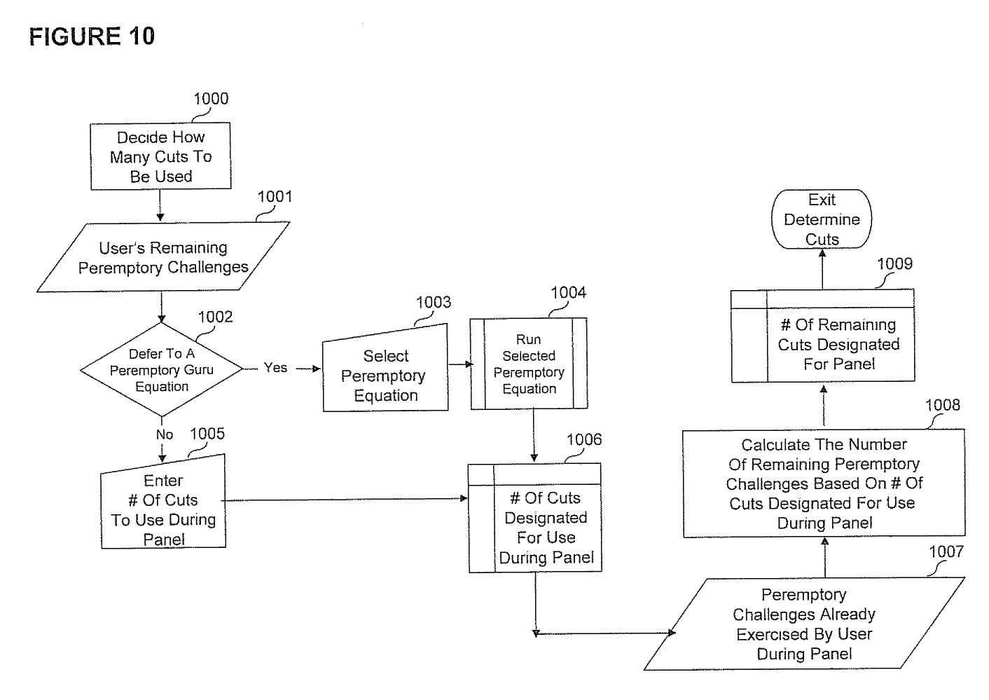

Referring to FIG. 10, one embodiment of the system allows the user to either: (1) enter the number of peremptory challenges that the attorney wants to designate for use during the current panel 1005: or (2) defer to one or more of the aforementioned peremptory equations to designate the appropriate number of peremptory challenges for use during the panel 1002. If the user decides to defer to a peremptory equation, then the user selects 1003 that equation, and the system performs 1004 the calculations required by that specific peremptory equation. Whatever the user decides, the system can save and store 1006 the number of cuts designated by the user for use during the current panel.

The system may require the user to enter 1007 each peremptory challenge exercised during the panel. The system can calculates 1008 the number of peremptory challenges the user has remaining based on: (1) the peremptory challenges already exercised by the user during the panel 1007 and (2) the number of peremptory challenges designated by the user for use during the panel 1006. The system can save and store 1009 the number of remaining peremptory challenges designated for use during the panel.

Decision To Cut

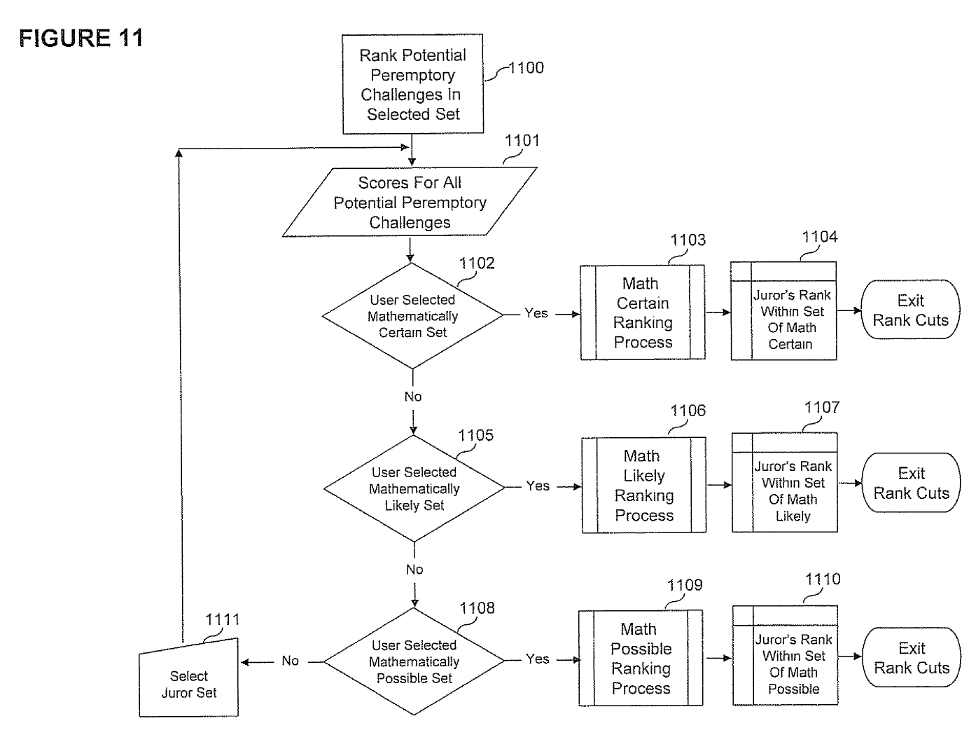

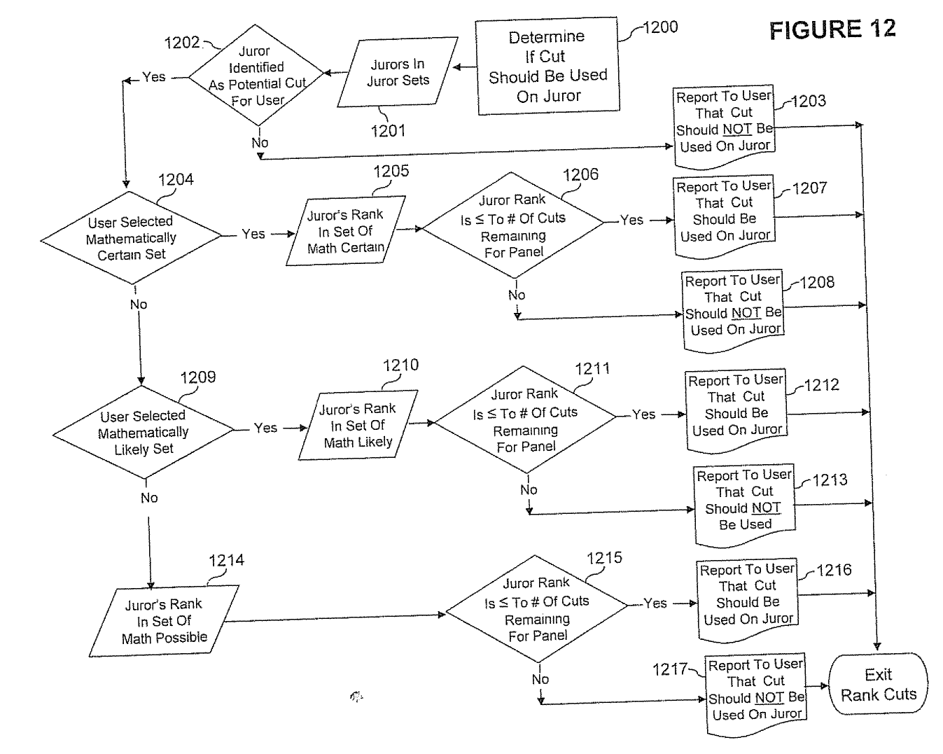

Referring now to FIGS. 11 and 12, the system can recommend 1200 that a prospective juror be peremptorily challenged by the user only when it determines that the juror's rank 1104, 1107, or 1110 within the set selected by the user 900 is less than, or equal to, the number of remaining peremptory challenges 1206, 1211, or 1215 designated for use during the panel. If the juror's rank within the set selected by the user is greater than the number of remaining peremptory challenges, then the system advises the user not to exercise a peremptory challenge on that juror.

Batson Function

An embodiment of the invention can analyze the peremptory challenges, the selections, and the challenges for cause made by an attorney, and determines whether there exists a prima facie case of purposeful discrimination. An attorney may not purposefully discriminate against a member of a suspect class. An embodiment of the invention can analyze the peremptory challenges, the selections, and the challenges for cause made by an attorney, and determines whether there is a prima facie case for purposeful discrimination.

One embodiment of the invention can determine statistical data regarding all suspect classes, including: (1) the percentage of prospective jurors who are members of the suspect class; (2) the percentage of selected jurors who are members of the suspect class; (3) the percentage of peremptory challenges exercised by an attorney to dismiss members of the suspect class: (4) the percentage of granted and/or denied challenges for cause made by any attorney seeking to dismiss members of the suspect class; and (4) the percentage of jurors already selected who are members of the suspect class.

An embodiment of the invention can report statistical data about the suspect class to the user. For example, the invention can report: (1) the percentage of prospective jurors who are members of the suspect class; (2) the percentage of selected jurors who are members of the suspect class; (3) the percentage of peremptory challenges who were exercised on members of the suspect class; (4) the percentage of challenges for cause made by an attorney on members of the suspect class: and (5) the percentage of denied challenges for cause made by an attorney on members of the suspect class.

One embodiment of the invention can provide a user with a warning when the statistical data suggests that an attorney is purposefully discriminating against members of a suspect class. That warning is hereinafter referred to as a “Batson warning.”

One embodiment of the invention allows the user to enter a percentage or ratio which, when equaled or exceeded by the conduct of an attorney, would cause the program to warn the user of a possible Batson violation, that percentages or ratio is hereinafter referred to as a “Batson threshold.”

For example, a user selects, as the Batson threshold, a 30% disparity between the percentage of peremptory challenges exercised by an attorney on members of a suspect class and the percentage of prospective jurors who are members of the suspect class. Jury selection begins. Despite the fact that only 10 of the 100 prospective jurors are members of the suspect class, the attorney exercises the first and second of his allotted four peremptory challenges on members of the suspect class. Because the attorney exercise 50% of his peremptory challenges on members of a suspect class that constituted only 10% of prospective jurors, the invention would issue a Batson warning to the user.

The Trial Data Bank

Am embodiment of the invention allows a user to enter information about the trial. The system organizes, saves, and stores this collected or harvested information in a database or databank (hereinafter “The Trial Data Bank”) The system can permit a user to search previously saved data in the Trial Data Bank.

One embodiment of the invention allows a user to enter biographical data into the Trial Data Bank, including but not limited to the following data about each prospective juror: name; address; age; gender; race; religion; job; position; marital status; number of children; prior jury service,

An embodiment of the invention allows a user to enter factual data about the case itself into the Trial Data Bank. That information includes, but is not limited to, the following categories: the case caption; the case number; the venue; the judge; the courtroom; the date of the trial; the parties; the attorneys; the legal and factual issues presented in the jury interrogatories; the lay and expert witnesses who testified during the trial; the allocation of fault; the damage award prayed for in the plaintiff's closing statement; and the verdict.

An embodiment of the invention allows a user to enter subjective data about the trial into the Trial Data Bank. That information includes, but is not limited to, the following categories: the attorney's description or evaluation of the verdict (i.e., defense verdict versus plaintiff verdict; reasonable award versus excessive award); and the attorney's description or evaluation of a juror's service (i e. attentive versus distracted).

An embodiment of the invention allows a user to search the Trial Data Bank to Find any data previously entered and saved in the Trial Data Bank.

An embodiment of the invention organizes, saves, and stores the data entered by a user by the venue of the trial. The invention allows a user to limit or expand a search for data in the Trial Data Bank to include: all courts; all federal courts; all state courts; specific states or combination of states; courts in specific appellate jurisdictions; specific counties and parishes, or combination of counties and parishes; specific judicial districts; specific sections of a judicial district court; and specific judges.

An embodiment of the invention organizes, saves, and stores the data entered by a user by the type of case. An embodiment of the invention allows a user to limit or expand a search for data in the Trial Data Bank to include: all trials; civil trials, criminal trials.

An embodiment of the invention organizes, saves, and stores the data entered by users during criminal jury trials by the charge(s) brought against the criminal defendant during that criminal jury trial. An embodiment of the invention allows a user to limit or expand a search for data in the Trial Data Bank to include: death penalty trials, murder trials, rape trials, armed robbery trials, burglary trials, drug distribution trials, drug possession trials, and any charge.

An embodiment of the invention organizes, saves, and stores the data entered by a user by the nature of the case. An embodiment of the invention allows a user to limit or expand a search for data in the Trial Data Bank to include: environmental cases, construction cases, expropriation cases, employment discrimination cases, toxic tort cases, admiralty and maritime cases, commercial cases, personal injury cases, and any other type of case.

An embodiment of the invention organizes, saves, and stores the data entered by a user by the type of claims included on the jury interrogatory. An embodiment of the invention allows a user to limit or expand a search for data in the Trial Data Bank to include: wrongful death cases, survival actions, claims for loss of future earnings, and other claims.

An embodiment of the invention organizes, saves, and stores the data entered by a user by the type of injuries alleged in the case. An embodiment of the invention allows a user to limit or expand a search for data in the Trial Data Bank to include: brain injury, quadriplegia, paraplegia, cervical injuries, lumbar injuries, loss of sight, loss of hearing, loss of limb, asbestosis, burns, and other common and uncommon injuries.

The Network

In some embodiments, the system can be run through a computer network (hereinafter “The Network”), which would: (1) limit access to the invention and to data previously stored in the Trial Data Bank; (2) allow an attorney to provide access to additional people and to define the level of access or participation for each person; (3) allow more than one person to log-on the Network, and to participate as an observer, a biographer, or a contributor; (4) allow a user to factor in, or defer to, the opinions of other contributors in “real time” with jury selection.

In one embodiment, the system can be saved, distributed, and sold on all forms of software, including but not limited to Compact Discs (hereinafter CDs).

The system can also be run through a computer network (hereinafter “the Network”), which limits access to the system, and to the data previously stored in the Trial Data Bank. An embodiment of the invention allows a user to provide access to additional people, and to define the level of access or participation for each person.

An embodiment of the invention allows more than one user to log-on to the computer network, and to participate in real time with jury selection. This function allows interested people located outside the courtroom to follow or participate in jury selection. An embodiment of the invention allows a user to determine the level of access or participation for each additional person, including but not limited to, (1) Observer Level Access; (2) Biographer Level Access; and (3) Contributor Level Access

An embodiment of the invention allows a user to authorize one or more people to log-on and to observe the process of jury selection, but not to enter any data into the system or computer network. These additional people are hereinafter referred to as “Observers.”

An embodiment of the invention allows a user to authorize one or more people to log-on, and to enter biographical data about the prospective jurors. These additional people are hereinafter referred to as “Biographers.”One embodiment of the invention distinguishes and separately identify the data entered by two or more Biographers. For example, an embodiment of the invention can distinguish between Biographers by: (1) presenting the data entered by the different Biographers in colors or script specifically assigned to each Biographer; (2) presenting the data entered by the different Biographers in separate columns, rows, sections, or screens; or (3) separately presenting the data entered by different Biographers.

An embodiment of the invention allows a user to authorize and allow additional people to contribute during jury selection by entering the data required by the system, including but not limited to: (1) entering potential challenges for cause; (2) entering potential peremptory challenges for the user's client; and (3) entering a score for each potential peremptory challenge. These additional people are hereinafter referred to as “Contributors.”

An embodiment of the invention can distinguish and separately identify the data entered by two or more Contributors. For example, the invention can distinguish between Contributors by: (1) presenting the data entered by the different Contributors in colors or script specifically assigned to each Contributor; (2) presenting the data entered by the different Contributors in separate columns, rows, sections, or screens, or (3) separately presenting the data entered by different Contributors

An embodiment of the invention allows a user to defer to the opinions of one or more other Contributors. For example, the invention allows a user to defer to another Contributor's opinion regarding which prospective jurors are potential challenges for cause, the probability of dismissal for each prospective juror, which prospective jurors are potential peremptory challenges, and the appropriate score or ranking for potential peremptory challenge.

While preferred embodiments of this invention have been shown and described, modifications thereof can be made by one skilled in the art without departing from the spirit or teaching of this invention. The embodiments described herein are exemplary only and are not limiting. Many variations and modifications of the system and frame are possible and are within the scope of the invention. Accordingly, the scope of protection is not limited to the embodiments described herein, but is only limited by the claims that follow, the scope of which shall include all equivalents of the subject matter of the claims.

1. A method for exercising peremptory challenges during jury selection at a jury trial, comprising:
determining the rules governing jury selection for the trial;
evaluating the prospective jurors;
evaluating the probability of dismissal for each prospective juror;
determining the maximum number of selection decisions;
determining a plurality of mathematical juror sets:
selecting at least one of the mathematical juror sets;
ranking the jurors within each selected mathematical juror set;
determining the number of peremptory challenges to use for each panel; and
recommending which prospective jurors should be peremptorily challenged.

2. The method of claim 1, further comprising creating a trial data bank.

3. The method of claim 1, wherein the step of determining the rules governing jury selection comprises entering the number of jurors who will be selected to serve on the jury, the number of alternate jurors, and the number of peremptory challenges allowed by the court.

4. The method of claim 1, wherein the step of evaluating the prospective jurors comprises recording a score for each prospective juror that indicates the relative desirability of the prospective juror.

5. The method of claim 1, wherein the step of evaluating the probability of dismissal comprises recording the probability, denoted as a number, that each prospective juror will be dismissed for cause by the court.

6. The method of claim 1, wherein the step of determining the maximum number of selection decisions comprises adding the number of jurors who will be selected to serve on the jury and the total number of peremptory challenges allowed by the court to be exercised by the parties.

7. The method of claim 1, wherein, before the step of determining a plurality of mathematical juror sets, the method further comprises determining the last actual juror.

8. The method of claim 7, wherein, before the step of determining a plurality of mathematical juror sets, the method further comprises determining the last possible juror.

9. The method of claim 8, wherein, before the step of determining a plurality of mathematical juror sets, the method further comprises determining the last likely juror.

10. The method of claim 1, wherein the step of determining a plurality of mathematical juror sets comprises determining the mathematically certain jurors.

11. The method of claim 10, wherein the step of determining a plurality of mathematical juror sets further comprises determining the mathematically possible jurors.

12. The method of claim 11, wherein the step of determining a plurality of mathematical juror sets further, comprises determining the mathematically likely jurors.

13. The method of claim 1, wherein the step of ranking the jurors within each selected mathematical juror set further comprising ranking the prospective jurors within each selected mathematical set from the least desirable to the least undesirable based upon the score previously recorded by the attorney in the step of evaluating the prospective jurors and a weighted average of the score determined in the step of evaluating the prospective jurors and the probability of dismissal determined in the step of evaluating the probability of dismissal for each prospective juror.

14. The method of claim 1, wherein the step of determining the number of peremptory challenges to use for each panel further comprising determining the percentage of peremptory challenges that would be equal to the percentage of eligible jurors in the panel assuming no additional prospective jurors are dismissed for cause in the panel.

15. The method of claim 14, wherein the step of determining the number of peremptory challenges to use for each panel further comprising determining the lowest possible percentage of mathematically eligible jurors in the panel.

16. The method of claim 15, wherein the step of determining the number of peremptory challenges to use for each panel further comprising determining the expected percentage of mathematically eligible jurors in the panel.

17. The method of claim 16, wherein the step of determining the number of peremptory challenges to use for each panel further comprising determining the percentage of jurors already selected.

18. The method of claim 17, wherein the step of determining the number of peremptory challenges to use for each panel further comprising determining the percentage of peremptory challenges already exercised by opposing counsel.

19. The method of claim 1, wherein the step of recommending which prospective jurors should be peremptorily challenged further comprising recommending that a prospective juror be peremptorily challenged when the ranking of that juror within the selected mathematical juror set is less than or equal to the number of remaining peremptory challenges designated for the panel.

20. The method of claim 1, further comprising of notifying when a prima facie case of purposeful discrimination exists in the exercise of peremptory challenges.

21. The method of claim 20, where the step of notifying further, comprises providing statistical information that indicates the prima facie case.

22. The method of claim 1, further comprising utilizing one or more peremptory equations to determine the number of peremptory challenges to use in cutting jurors in the panel

23. A method for exercising peremptory challenges to prospective jurors during jury selection at a jury trial comprising:
entering the number of principal jurors to be seated in the jury panel at trial, the number of alternate jurors required for the trial, and the number of peremptory challenges available for each of the parties to the trial;
entering the selection order of the prospective jurors;
entering all evaluation of the prospective jurors;
determining the probability of dismissal and the probability of survival of a challenge for cause of one or more of the prospective jurors;
determining the maximum number of times that a prospective juror will be selected or peremptorily challenged;
determining the last actual juror the last likely juror, and the last possible juror;
determining the set of mathematically certain jurors, the set of mathematically likely jurors, and the set of mathematically possible jurors;
selecting at least one of the mathematical juror sets;
determining the rank of the prospective jurors within each selected mathematical set from the least desirable to the least undesirable;
utilizing the peremptory equations to determine the number of peremptory challenges to use in cutting jurors in the panel; and
indicating that a peremptory challenge should be exercised if the ranking of that juror within the selected mathematical juror set is less than or equal to the number of remaining peremptory challenges designated for the panel.

24. The method of claim 23, further comprising creating a database containing information gathered on the prospective jurors.

25. The method of claim 24, further comprising using the database to compile statistics regarding the behavior of jurors that may be of assistance in forming opinions about which jurors are desirable or undesirable for service on a particular jury.

26. An information carrier medium that communicates software to a computer, wherein the software when executed assists in exercising peremptory challenges during jury selection comprising:
determining the rules governing jury selection for the trial;
evaluating the prospective jurors;
evaluating the probability of dismissal for each prospective juror;
determining the maximum number of selection decisions;
determining a plurality of mathematical juror sets:
selecting at least one of the mathematical juror sets;
ranking the jurors within each selected mathematical juror set;
determining the number of peremptory challenges to use for each panel; and
recommending which prospective jurors should be peremptorily challenged.

27. The information carrier medium in claim 26, further comprising indicating that a peremptory challenge should be exercised when the ranking of that juror within the selected mathematical juror set is less than or equal to the number of remaining peremptory challenges designated for the panel.
